(19) United States
(12) Patent Application Publication
(10) Pub. No.: US 2024/0410135 A1
(43) Pub. Date: Dec. 12, 2024

(54) CONTROL DEVICE OF WORK MACHINE

(71) Applicant: KOMATSU LTD., Minato-ku, Tokyo (JP)

(72) Inventors: Toshiaki KUMAGAI, Minato-ku, Tokyo (JP); Ryouhei KURAMATSU, Minato-ku, Tokyo (JP); Rio KAWANA, Minato-ku, Tokyo (JP); Kensuke FUJII, Minato-ku, Tokyo (JP); Motoki KOYAMA, Minato-ku, Tokyo (JP)

(73) Assignee: KOMATSU LTD., Minato-ku, Tokyo (JP)

(21) Appl. No.: 18/699,695

(22) PCT Filed: Aug. 24, 2022
(86) PCT No.: PCT/JP2022/031861

§ 371 Date: Apr. 9, 2024

(30) Foreign Application Priority Data
Oct. 18, 2021 (JP) 2021-170413

(51) Int. Cl. E02F 9/20; E02F 9/22; E02F 9/26; F02D 41/02

(52) U.S. Cl. CPC E02F 9/2066; E02F 9/26; E02F 9/264; F02D 41/021; E02F 9/2203; E02F 9/2285; E02F 9/2296

(57) ABSTRACT

A work machine includes a vehicular body, a work implement supported on the vehicular body, and an engine which is a drive source of the work implement. The control device of the work machine includes a rotation speed setting member manually operable for setting a target rotation speed of the engine and a controller that selectively carries out any one of ordinary control and intervention control. When ordinary control is carried out, an engine controller controls the engine at the target rotation speed based on an operation onto the rotation speed setting member. When intervention control is carried out, an intervention controller estimates contents of works by the work implement. The engine controller sets the target rotation speed corresponding to the estimated contents of works and controls the engine at the set target rotation speed regardless of an amount of operation onto the rotation speed setting member.

### TECHNICAL FIELD

The present disclosure relates to a control device of a work machine.

### BACKGROUND ART

Japanese Patent Laying-Open No. 3-279638 (PTL 1) discloses control for determining an engine rotation command value to be inputted to an engine in accordance with a state of throwing of a switch for selection of a work mode such as heavy excavation, excavation, leveling, and a fine operation and an engine rotation setting value inputted from a throttle opening setting unit.

### CITATION LIST

### Patent Literature

PTL 1: Japanese Patent Laying-Open No. 3-279638

### SUMMARY OF INVENTION

### Technical Problem

A work machine does various works. A series of works by the work machine may include a work not requiring engine output. Even during works not requiring engine output, for example, under the control in a “heavy excavation” work mode in which the number of rotations of the engine is maintained high, fuel is unnecessarily consumed.

The present disclosure proposes a control device of a work machine that achieves reduction in fuel consumption.

### Solution to Problem

According to the present disclosure, a control device of a work machine is proposed. The work machine includes a vehicular body, a work implement supported on the vehicular body, and an engine which is a drive source of the work implement. The control device of a work machine includes a rotation speed setting member manually operable for setting a target rotation speed of the engine and a controller that selectively carries out any one of ordinary control and intervention control. In carrying out the ordinary control, the controller controls the engine at the target rotation speed based on an operation onto the rotation speed setting member. In carrying out the intervention control, the controller estimates contents of works by the work implement, sets the target rotation speed corresponding to the estimated contents of works, and controls the engine at the set target rotation speed regardless of an amount of operation onto the rotation speed setting member.

### Advantageous Effects of Invention

According to the control device of the work machine in the present disclosure, fuel consumption can be reduced and fuel efficiency can be improved.

### BRIEF DESCRIPTION OF DRAWINGS

FIG. 1 is a side view schematically showing a construction of a work machine in an embodiment.

FIG. 2 is a block diagram showing a system configuration of the work machine shown in FIG. 1.

FIG. 3 is a block diagram showing a functional configuration of an intervention controller.

FIG. 4 is a flowchart showing a flow of processing for setting a target rotation speed of an engine.

FIG. 5 shows a table of exemplary work categorization.

FIG. 6 is a flowchart showing a flow of processing for selecting a command value.

FIG. 7 is a flowchart showing a flow of processing for selecting a command value in a second embodiment.

### DESCRIPTION OF EMBODIMENTS

An embodiment of the present disclosure will be described below with reference to the drawings.

The same or corresponding components in the specification and the drawings have the same reference characters allotted and redundant description will not be repeated. In the drawings, a feature may not be shown or simplified for the sake of convenience of illustration.

In the description below, “up”, “down”, “front”, “rear”, “left”, and “right” refer to directions with an operator seated in an operator's seat 2b within an operator's cab 2a being defined as the reference.

### First Embodiment

### <Construction of Work Machine>

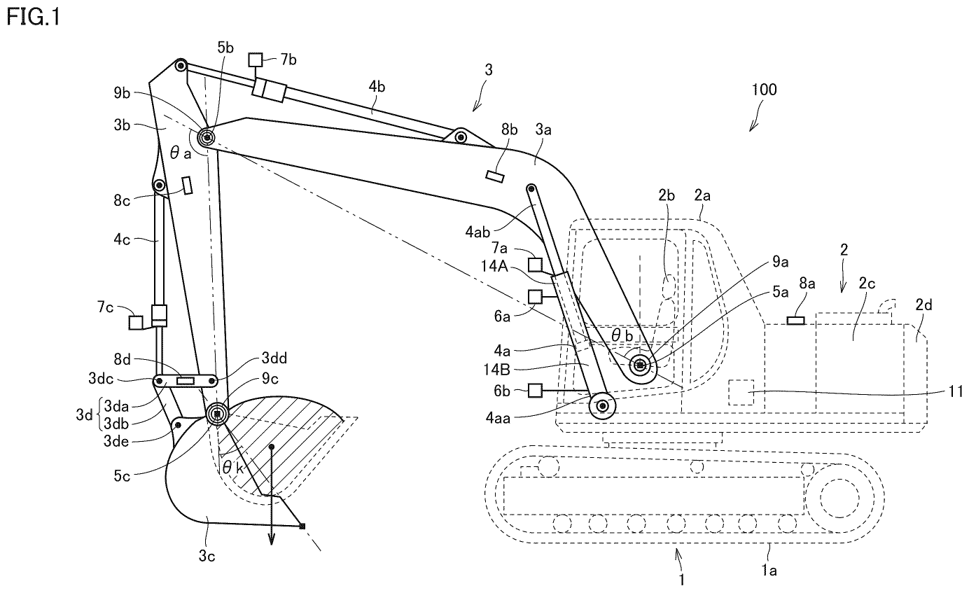

FIG. 1 is a side view schematically showing a construction of a hydraulic excavator 100 as an exemplary work machine in an embodiment. As shown in FIG. 1, hydraulic excavator 100 in the present embodiment mainly includes a travel unit 1, a revolving unit 2, and a work implement 3. A vehicular body of hydraulic excavator 100 is constituted of travel unit 1 and revolving unit 2.

Travel unit 1 includes a pair of left and right crawler belt apparatuses 1a. Each of the pair of left and right crawler belt apparatuses 1a includes a crawler belt. As a pair of left and right crawler belts is rotationally driven, hydraulic excavator 100 travels.

Revolving unit 2 is provided as being revolvable with respect to travel unit 1. Revolving unit 2 mainly includes operator's cab (cab) 2a, operator's seat 2b, an engine compartment 2c, and a counterweight 2d. Operator's cab 2a is arranged, for example, on the forward left (on a front side of a vehicle) of revolving unit 2. Operator's seat 2b where the operator takes a seat is arranged in an internal space in operator's cab 2a.

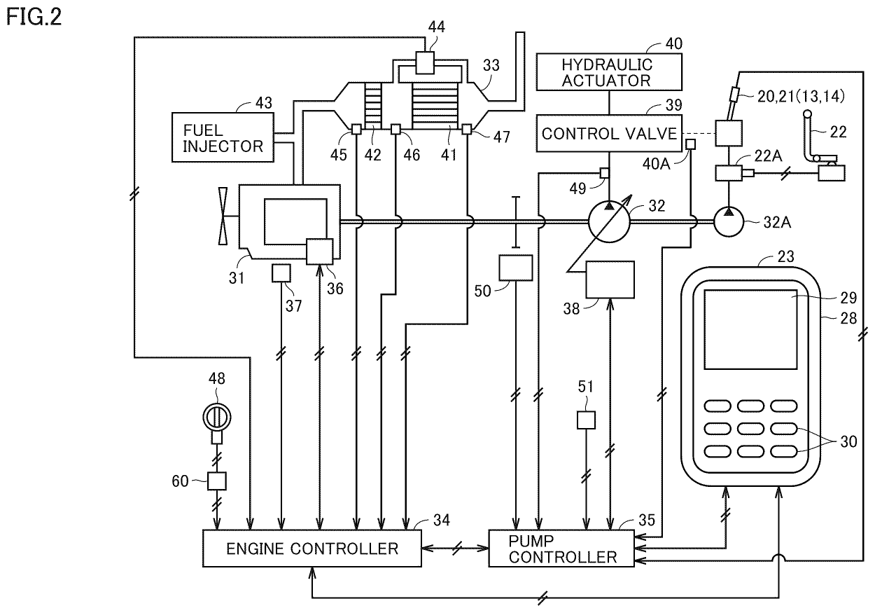

Each of engine compartment 2c and counterweight 2d is arranged in a rear portion (on a rear side of the vehicle) of revolving unit 2 with respect to operator's cab 2a. An engine unit (an engine 31 (FIG. 2), and an exhaust treatment structure) is accommodated in engine compartment 2c. An engine hood covers the top of engine compartment 2c. Counterweight 2d is arranged in the rear of engine compartment 2c.

Work implement 3 is supported on revolving unit 2 on the front side of revolving unit 2, and for example, on the right of operator's cab 2a. Work implement 3 includes, for example, a boom 3a, an arm 3b, a bucket 3c, a boom cylinder 4a, an arm cylinder 4b, and a bucket cylinder 4c. Boom 3a has a base end pivotably coupled to revolving unit 2 with a boom foot pin 5a being interposed. Arm 3b has a base end pivotably coupled to a tip end of boom 3a with a boom top pin 5b being interposed. Bucket 3c is pivotably coupled to a tip end of arm 3b with an arm top pin 5c being interposed.

Boom 3a can be driven by boom cylinder 4a. As a result of this drive, boom 3a can pivot around boom foot pin 5a in an upward/downward direction with respect to revolving unit 2. Arm 3b can be driven by arm cylinder 4b. As a result of this drive, arm 3b can pivot around boom top pin 5b in the upward/downward direction with respect to boom 3a. Bucket 3c can be driven by bucket cylinder 4c. As a result of this drive, bucket 3c can pivot around arm top pin 5c in the upward/downward direction with respect to arm 3b. Work implement 3 can thus be driven.

Work implement 3 includes a bucket link 3d. Bucket link 3d includes a first link member 3da and a second link member 3db. A tip end of first link member 3da and a tip end of second link member 3db are coupled to each other as being pivotable relative to each other with a bucket cylinder top pin 3dc being interposed. Bucket cylinder top pin 3dc is coupled to the tip end of bucket cylinder 4c. Therefore, first link member 3da and second link member 3db are coupled to bucket cylinder 4c with the pin being interposed.

First link member 3da has a base end pivotably coupled to arm 3b with a first link pin 3dd being interposed. Second link member 3db has a base end pivotably coupled to a bracket at a root of bucket 3c with a second link pin 3de being interposed.

A pressure sensor 6a is attached to a head side of boom cylinder 4a. Pressure sensor 6a can detect a pressure (a head pressure) of hydraulic oil within a cylinder-head-side oil chamber 14A of boom cylinder 4a. A pressure sensor 6b is attached to a bottom side of boom cylinder 4a. Pressure sensor 6b can detect a pressure (a bottom pressure) of hydraulic oil within a cylinder-bottom-side oil chamber 14B of boom cylinder 4a.

Stroke sensors 7a, 7b, and 7c are attached to boom cylinder 4a, arm cylinder 4b, and bucket cylinder 4c, respectively. Stroke sensor 7a detects an amount of displacement of a cylinder rod 4ab with respect to a cylinder 4aa in boom cylinder 4a. Stroke sensor 7b detects an amount of displacement of the cylinder rod in arm cylinder 4b. Stroke sensor 7c detects an amount of displacement of the cylinder rod in bucket cylinder 4c.

Angle sensors 9a, 9b, and 9c may be attached around boom foot pin 5a, boom top pin 5b, and arm top pin 5c, respectively. Angle sensors 9a, 9b, and 9c may each be implemented by a potentiometer or a rotary encoder.

As shown in FIG. 1, in the side view, an angle formed between a straight line (shown with a chain double-dotted line in FIG. 1) that passes through boom foot pin 5a and boom top pin 5b and a straight line (shown with a dashed line in FIG. 1) that extends in the upward/downward direction is defined as a boom angle θb. Boom angle θb is normally an acute angle. Boom angle θb represents an angle of boom 3a with respect to revolving unit 2. Boom angle θb can be calculated from a result of measurement by stroke sensor 7a and a measurement value from angle sensor 9a.

In the side view, an angle formed between the straight line that passes through boom foot pin 5a and boom top pin 5b and a straight line (shown with a chain double dotted line in FIG. 1) that passes through boom top pin 5b and arm top pin 5c is defined as an arm angle θa. Arm angle θa represents an angle of arm 3b with respect to boom 3a in an area where arm 3b pivots in the side view. Arm angle θa can be calculated from a result of measurement by stroke sensor 7b and a measurement value from angle sensor 9b.

In the side view, an angle formed between the straight line that passes through boom top pin 5b and arm top pin 5c and a straight line (shown with a chain double dotted line in FIG. 1) that passes through arm top pin 5c and a cutting edge of bucket 3c is defined as a bucket angle θk. Bucket angle θk represents an angle of bucket 3c with respect to arm 3b in an area where bucket 3c pivots in the side view. Bucket angle θk can be calculated from a result of measurement by stroke sensor 7c and a measurement value from angle sensor 9c.

Inertial measurement units (IMUs) 8a, 8b, 8c, and 8d are attached to revolving unit 2, boom 3a, arm 3b, and first link member 3da, respectively. IMU 8a measures an acceleration of revolving unit 2 in a fore/aft direction, a lateral direction, and the upward/downward direction and an angular velocity of revolving unit 2 around the fore/aft direction, the lateral direction, and the upward/downward direction. IMUs 8b, 8c, and 8d measure accelerations of boom 3a, arm 3b, and first link member 3da in the fore/aft direction, the lateral direction, and the upward/downward direction and angular velocities of boom 3a, arm 3b, and first link member 3da around the fore/aft direction, the lateral direction, and the upward/downward direction, respectively.

Based on a difference between the acceleration measured by IMU 8a attached to revolving unit 2 and the acceleration measured by IMU 8b attached to boom 3a, an acceleration in extension and contraction of boom cylinder 4a (an amount of change in speed of extension and contraction of boom cylinder 4a) can be obtained. Boom angle θb, arm angle θa, and bucket angle θk may be calculated from results of detection by respective IMUs 8b, 8c, and 8d.

IMU 8a serves as a vehicular body position sensor attached to the vehicular body of the work machine to detect a position of the vehicular body. Stroke sensors 7a, 7b, and 7c, angle sensors 9a, 9b, and 9c, and IMUs 8b, 8c, and 8d each serve as a work implement position sensor attached to work implement 3 to detect a position of work implement 3.

Hydraulic excavator 100 further includes a payload meter 11. Payload meter 11 is mounted, for example, on revolving unit 2. Payload meter 11 measures a weight of loads such as soil scooped by hydraulic excavator 100. Payload meter 11 measures a weight of loads loaded in bucket 3c. A pressure applied to boom cylinder 4a is detected by pressure sensors 6a and 6b. Payload meter 11 converts magnitude of the pressure onto boom cylinder 4a detected by pressure sensors 6a and 6b into the weight of loads loaded in bucket 3c.

### <System Configuration>

A system configuration of the work machine will now be described with reference to FIG. 2. FIG. 2 is a block diagram showing a system configuration of the work machine shown in FIG. 1. The system in the embodiment shown in FIG. 2 is a system for control of engine 31 and includes an engine controller 34.

Engine 31 is a diesel engine driven with light oil being used as fuel oil. Engine 31 includes a common rail fuel injection apparatus (not shown), a fuel pump 36 that delivers fuel to the common rail, and an engine coolant temperature sensor 37 that detects a temperature of water for cooling of engine 31. Engine 31 has an output shaft connected to a hydraulic pump 32.

Hydraulic pump 32 is an axial piston pump that includes a swash plate driven by a swash plate drive apparatus 38 and regulates a delivery pressure of hydraulic oil based on a position of the swash plate. A hydraulic actuator 40 is connected to a hydraulic oil delivery side of hydraulic pump 32 with a control valve 39 being interposed. Hydraulic actuator 40 includes a hydraulic motor for revolution and a hydraulic motor for travel which are not shown, in addition to boom cylinder 4a, arm cylinder 4b, and bucket cylinder 4c described with reference to FIG. 1.

Work implement 3 is driven by hydraulic oil delivered by hydraulic pump 32. Hydraulic pump 32 is driven by engine 31. Engine 31 is a source of drive of operations of work implement 3. Engine 31 generates drive force for operating work implement 3 by being rotationally driven by supply of fuel.

A hydraulic pump 32A for generation of a pilot pressure is connected to hydraulic pump 32. A delivery side of hydraulic pump 32A is connected to control levers 20 and 21 and travel levers 13 and 14 through a pilot channel. When control lever 20 or 21 or travel lever 13 or 14 is operated, a delivery pressure of control valve 39 changes through the pilot channel and hydraulic actuator 40 operates. Engine 31 and hydraulic pump 32 are mounted on revolving unit 2.

Control levers 20 and 21 are arranged, for example, on a lateral side of operator's seat 2b in operator's cab 2a. Control lever 20 is an operation apparatus, for example, for a pivot operation of arm 3b and a revolution operation of revolving unit 2. Control lever 21 is an operation apparatus, for example, for upward and downward movement of boom 3a and pivot of bucket 3c. Travel levers 13 and 14 are arranged, for example, in front of operator's seat 2b in operator's cab 2a. Travel levers 13 and 14 are each an operation apparatus for travel of travel unit 1.

A solenoid valve 22A is provided between hydraulic pump 32A and control levers 20 and 21 and travel levers 13 and 14. A locking lever 22 is an operation apparatus for deactivation of functions such as operations of work implement 3, revolution of revolving unit 2, and travel of travel unit 1. When locking lever 22 is operated toward a locking side, solenoid valve 22A disconnects the pilot channel. Even when an operator operates control lever 20 or 21 or travel lever 13 or 14 in this state, hydraulic actuator 40 is not driven and hence work implement 3 or the like does not operate.

An operation detector 40A is a sensor that detects whether or not control lever 20 or 21 or travel lever 13 or 14 has been operated, and it may be an analog sensor or an on-off sensor. Operation detector 40A may be a pressure sensor that is provided, for example, in the pilot channel through which an operation onto control lever 20 or 21 or travel lever 13 or 14 is transmitted to control valve 39 to detect a pressure of pilot oil in the pilot channel. Instead of the pressure sensor, a potentiometer may be incorporated in control levers 20 and 21 and the like, and this potentiometer may determine whether or not the lever has been operated.

A monitor apparatus 23 shows various states (an engine coolant temperature, a hydraulic oil temperature, a remaining amount of fuel, and the like) of hydraulic excavator 100. Monitor apparatus 23 is arranged, for example, in operator's cab 2a. Monitor apparatus 23 is arranged, for example, in front of operator's seat 2b in operator's cab 2a. Monitor apparatus 23 includes an exterior case 28, a monitor screen 29, and an operation switch 30. Monitor screen 29 and operation switch 30 are provided on a front surface of exterior case 28. Monitor screen 29 is implemented, for example, by a liquid crystal panel. Operation switch 30 includes at least one switch to be operated by the operator. Operation switch 30 may be separate from monitor apparatus 23, that is, may be provided in an instrument panel in operator's cab 2a.

An exhaust gas purification apparatus 33 is an apparatus that removes particulate matters (PM) contained in exhaust gas from engine 31 and includes a filter 41 and an oxidation catalyst 42.

Filter 41 is made of a material such as ceramic and catches PM contained in exhaust gas.

Oxidation catalyst 42 performs a function to reduce nitrogen monoxide (NO) in nitrogen oxide (NOx) in exhaust gas and to increase nitrogen dioxide (NO₂). Oxidation catalyst 42 performs also a function to recondition filter 41 by oxidizing hydrocarbon injected from a fuel injector 43 provided upstream from oxidation catalyst 42 in a flow of exhaust gas and burning PM caught by filter 41 with reaction heat generated by oxidation reaction. For example, light oil which serves as fuel can be used as hydrocarbon to be injected from fuel injector 43.

Exhaust gas purification apparatus 33 is provided with a pressure difference sensor 44 that detects a pressure difference between an inlet side and an outlet side of filter 41 and temperature sensors 45, 46, and 47 that detect temperatures at an inlet of exhaust gas purification apparatus 33, an inlet of filter 41, and an outlet of exhaust gas purification apparatus 33, respectively. Detection values from these sensors 44 to 47 are outputted to engine controller 34 as electrical signals.

Engine controller 34 controls the number of rotations or a rotation speed of engine 31 by outputting a control signal to fuel pump 36 of engine 31 to control an amount of fuel injected from a not-shown fuel injection apparatus. A water temperature detected by engine coolant temperature sensor 37 provided in engine 31 during operations of engine 31 that is being controlled or the like is outputted to monitor apparatus 23 as an electrical signal.

A pump controller 35 controls swash plate drive apparatus 38 based on detection values from a pump pressure sensor 49 that detects a pressure of delivery by hydraulic pump 32, an engine rotation sensor 50 provided in the output shaft that connects engine 31 and hydraulic pump 32 to each other, and a hydraulic oil temperature sensor 51 that detects a temperature of hydraulic oil supplied to hydraulic actuator 40. Pump controller 35 generates data as to whether or not control lever 20 or 21 or travel lever 13 or 14 has been operated based on operation detector 40A that detects a pressure in the pilot channel and outputs the data to monitor apparatus 23 as an electrical signal.

Monitor apparatus 23, engine controller 34, and pump controller 35 are communicatively connected to one another over controller area network (CAN).

A rotation speed setting member 48 is a member that sets a target rotation speed of engine 31 by setting a target value of an amount of fuel supply to engine 31. Rotation speed setting member 48 is provided, for example, in an instrument panel on the right of operator's cab 2a in operator's cab 2a. Rotation speed setting member 48 is, for example, a member like a dial and provided as being manually operable. Rotation speed setting member 48, however, may be another member such as a lever, a pedal, or a switch.

Rotation speed setting member 48 outputs to engine controller 34, an operation signal indicating an amount of operation thereonto. The operation signal is inputted to engine controller 34, for example, as a voltage value. Engine controller 34 sets the target rotation speed of engine 31 in accordance with the operation signal inputted from rotation speed setting member 48. Engine controller 34 controls engine 31 at the set target rotation speed.

An intervention controller 60 interposed in a signal path between rotation speed setting member 48 and engine controller 34 is provided. The “controller” in the embodiment includes engine controller 34 and intervention controller 60.

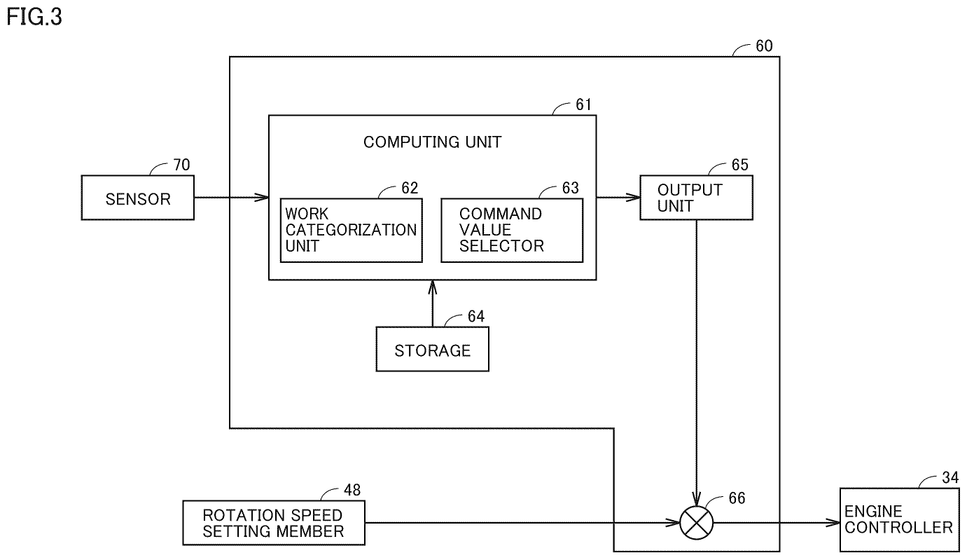

FIG. 3 is a block diagram showing a functional configuration of intervention controller 60. As shown in FIG. 3, intervention controller 60 mainly includes a computing unit 61, a storage 64, an output unit 65, and a switch 66.

Computing unit 61 includes a work categorization unit 62. Work categorization unit 62 estimates contents of works by work implement 3. For example, a result of detection by a sensor 70 is used for estimation of contents of works by work implement 3. Sensor 70 includes IMUs 8a, 8b, 8c, and 8d and pressure sensors 6a and 6b described with reference to FIG. 1. Sensor 70 may include stroke sensors 7a, 7b, and 7c and angle sensors 9a, 9b, and 9c. Sensor 70 may include an operation amount sensor such as a potentiometer that detects an amount of operation onto control lever 20 or 21. In order to estimate contents of works by work implement 3, results of detection by the vehicular body position sensor and the work implement position sensor are used.

Sensor 70 is electrically connected to intervention controller 60. Therefore, results of detection by pressure sensors 6a and 6b, the vehicular body position sensor (IMU 8a), and the work implement position sensor (stroke sensors 7a, 7b, and 7c, angle sensors 9a, 9b, and 9c, and IMUs 8b, 8c, and 8d) are directly inputted to intervention controller 60. Sensor 70 may be connected to intervention controller 60 through a wire or wirelessly.

In order to estimate contents of works by work implement 3, a weight of loads loaded on work implement 3 (bucket 3c) measured by payload meter 11 based on results of detection by pressure sensors 6a and 6b may be used.

A result of previous estimation of contents of works may be used for estimation of contents of works by work implement 3. In a series of works including excavation of soil by hydraulic excavator 100 and loading of excavated soil onto a carrier vehicle such as a dump truck, characteristic operations including excavation, loaded revolution, soil ejection, and unloaded revolution are repeated in this order. By determining whether or not presently estimated contents of works are to be done immediately after the previously estimated contents of works and estimating contents of works in consideration of seriality of works, accuracy in estimation of contents of works can be enhanced.

Computing unit 61 includes a command value selector 63. Command value selector 63 selects a command value corresponding to the contents of works estimated by work categorization unit 62.

Work categorization unit 62 and command value selector 63 perform processing by reading as appropriate, a program, a parameter, a threshold value, or the like stored in storage 64.

Output unit 65 outputs a signal indicating a command value selected by command value selector 63. The command value is inputted to engine controller 34, for example, as a voltage value. The command value inputted from output unit 65 into engine controller 34 and the operation signal inputted from rotation speed setting member 48 to engine controller 34 are physical quantities of the same type, that is, the voltage values. Output unit 65 is implemented as a voltage output device.

Switch 66 is electrically connected to a signal path between rotation speed setting member 48 and engine controller 34. Switch 66 can switch between setting to allow input of the operation signal indicating the amount of operation onto rotation speed setting member 48 to engine controller 34 and not to allow input of the command value from intervention controller 60 to engine controller 34 and setting to allow input of the command value from intervention controller 60 to engine controller 34 and not to allow input of the operation signal indicating the amount of operation onto rotation speed setting member 48 to engine controller 34.

### <Control of Work Machine>

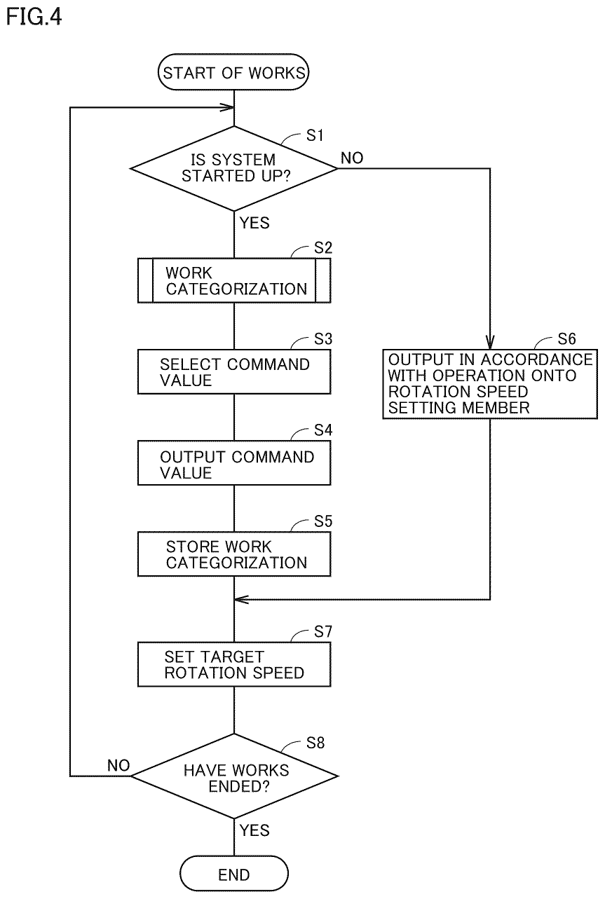

FIG. 4 is a flowchart showing a flow of processing for setting a target rotation speed of engine 31. A method of controlling hydraulic excavator 100 in the present embodiment will be described with reference, as appropriate, to FIGS. 4 and 3 and FIGS. 5 and 6 which will be described later. Control of engine 31 based on the present embodiment includes ordinary control and intervention control. The controller can selectively carry out any one of ordinary control and intervention control.

In ordinary control, the target rotation speed of engine 31 is set by an operation onto rotation speed setting member 48. When ordinary control is carried out, switch 66 is set such that the operation signal indicating the amount of operation onto rotation speed setting member 48 is inputted from rotation speed setting member 48 to engine controller 34. Engine controller 34 sets the target rotation speed of engine 31 based on the inputted amount of operation onto rotation speed setting member 48. Engine controller 34 controls engine 31 at the target rotation speed based on the operation onto rotation speed setting member 48.

In intervention control, the target rotation speed of engine 31 is automatically set in correspondence with contents of works by work implement 3. Intervention controller 60 estimates the contents of works by work implement 3 and selects a command value corresponding to the estimated contents of works. When intervention control is carried out, switch 66 is set such that a signal indicating the command value corresponding to the estimated contents of works is outputted from intervention controller 60 to engine controller 34. Engine controller 34 sets the target rotation speed of engine 31 based on the inputted command value and controls engine 31 at the set target rotation speed regardless of the amount of operation onto rotation speed setting member 48.

As shown in FIG. 4, in the embodiment, whether or not to start up the system is determined at the time of start of works (step S1). When the system is started up (YES in step S1), intervention control in which the target rotation speed of engine 31 is automatically set in correspondence with contents of works by work implement 3 is carried out. The system is automatically started up simultaneously with start of works. The system may be started up by an operation from a not-shown tablet computer that can communicate with intervention controller 60.

When the function to measure the weight of loads loaded on work implement 3 has been activated, the controller carries out intervention control. Activation or deactivation of the function is set through monitor apparatus 23. The function to measure the weight of loads loaded on work implement 3 is performed by payload meter 11. Payload meter 11 is switched on and off by an operation onto a manual switch or an external monitor operable by the operator. Which of intervention control and ordinary control is to be carried out may be determined by switching on and off of payload meter 11.

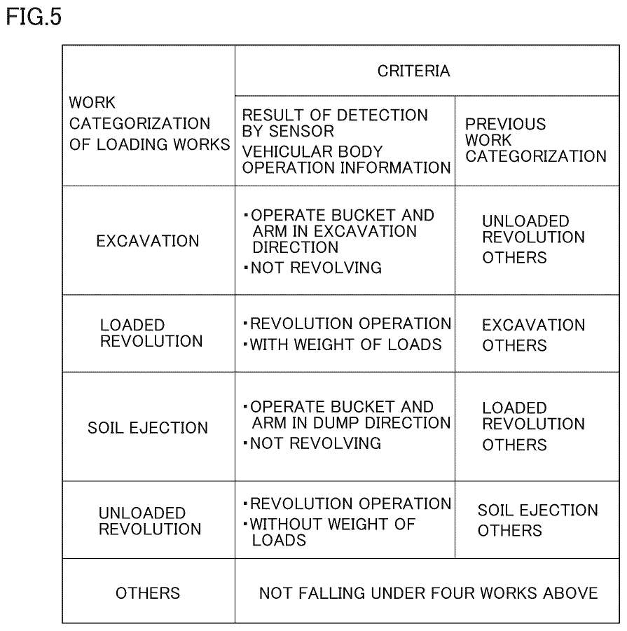

When intervention control is carried out, works are categorized in step S2. FIG. 5 shows a table of exemplary work categorization. FIG. 5 shows criteria for estimation of contents of works in the case of loading works in which excavation works, loaded revolution works, soil ejection works, and unloaded revolution works are repeatedly done in this order.

As shown in FIG. 5, work categorization unit 62 (FIG. 3) estimates the contents of works based on the result of detection by sensor 70, vehicular body operation information derived from the result of detection by sensor 70, and the result of previous estimation of contents of works.

Specifically, the operation of arm 3b is determined, for example, based on the result of detection by IMU 8c, stroke sensor 7b, and angle sensor 9b and the result of detection of the amount of operation onto control lever 20 for the operation of arm 3b. The operation of bucket 3c is determined, for example, based on the result of detection by IMU 8d, stroke sensor 7c, and angle sensor 9c and the result of detection of the amount of operation onto control lever 21 for the operation of bucket 3c. The revolution operation of revolving unit 2 is determined, for example, based on the result of detection by IMU 8a and the result of detection of the amount of operation onto control lever 20 for control of revolution of revolving unit 2. The weight of loads loaded on bucket 3c is determined based on results of detection by pressure sensors 6a and 6b.

The result of previous estimation of contents of works is stored in storage 64. Work categorization unit 62 reads the result of previous estimation of the contents of works from storage 64.

When bucket 3c is operated in an excavation direction which is a direction in which the cutting edge of bucket 3c comes closer to the vehicular body (in FIG. 1, a counterclockwise direction around arm top pin 5c), arm 3b is operated in the excavation direction in which the tip end of arm 3b comes closer to the vehicular body (in FIG. 1, the counterclockwise direction around boom top pin 5b), revolving unit 2 is not revolving, and the contents of previous works are determined as “unloaded revolution” or “others,” work categorization unit 62 determines the contents of works as “excavation”.

When revolving unit 2 is revolving, loads have been loaded in bucket 3c, and the contents of previous works are determined as “excavation” or “others”, work categorization unit 62 determines the contents of works as “loaded revolution.”

When bucket 3c is operated in a dump direction in which the cutting edge of bucket 3c moves away from the vehicular body (in FIG. 1, a clockwise direction around arm top pin 5c), arm 3b is operated in the dump direction in which the tip end of arm 3b moves away from the vehicular body (in FIG. 1, the clockwise direction around boom top pin 5b), revolving unit 2 is not revolving, and the contents of previous works are determined as “loaded revolution” or “others”, work categorization unit 62 determines the contents of works as “soil ejection.”

When revolving unit 2 is revolving, loads have not been loaded in bucket 3c, and the contents of previous works are determined as “soil ejection” or “others”, work categorization unit 62 determines the contents of works as “unloaded revolution.”

When the contents of works fall under none of “excavation”, “loaded revolution,” “soil ejection,” and “unloaded revolution,” work categorization unit 62 determines the contents of works as “others”.

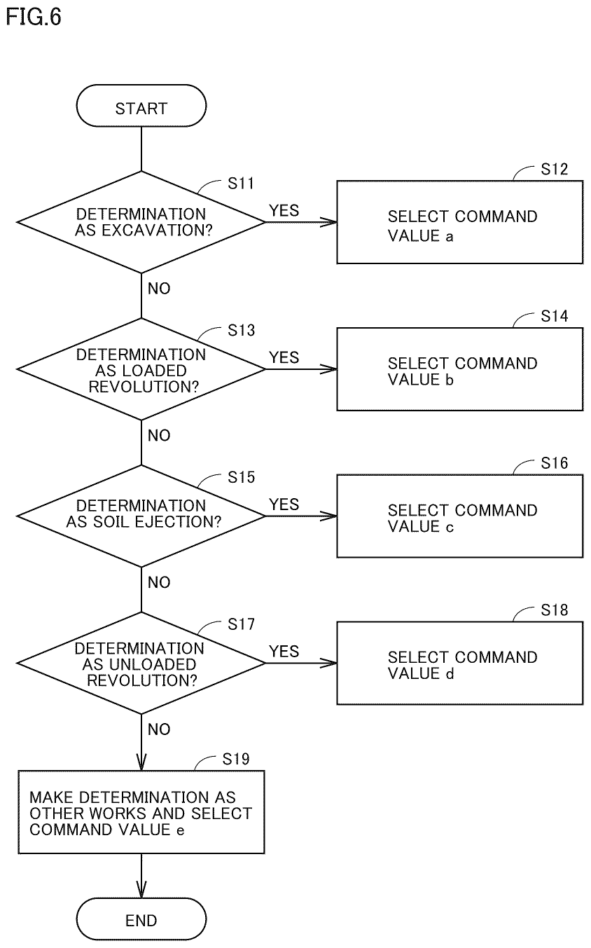

Referring back to FIG. 4, then in step S3, a command value corresponding to the contents of works is selected. FIG. 6 is a flowchart showing a flow of processing for selecting a command value. Command value selector 63 (FIG. 3) selects the command value in accordance with the flow shown in FIG. 6.

As shown in FIG. 6, whether or not the contents of works fall under “excavation” is determined (step S11). When the contents of works fall under “excavation” (YES in step S11), in step S12, command value selector 63 selects a command value a.

When the contents of works do not fall under “excavation” (NO in step S11), whether or not the contents of works fall under “loaded revolution” is determined (step S13). When the contents of works fall under “loaded revolution” (YES in step S13), in step S14, command value selector 63 selects a command value b.

When the contents of works do not fall under “loaded revolution” (NO in step S13), whether or not the contents of works fall under “soil ejection” is determined (step S15). When the contents of works fall under “soil ejection” (YES in step S15), in step S16, command value selector 63 selects a command value c.

When the contents of works do not fall under “soil ejection” (NO in step S15), whether or not the contents of works fall under “unloaded revolution” is determined (step S17). When the contents of works fall under “unloaded revolution” (YES in step S17), in step S18, command value selector 63 selects a command value d.

When the contents of works do not fall under “unloaded revolution” (NO in step S17), none of “excavation”, “loaded revolution,” “soil ejection,” and “unloaded revolution” works are applicable. Therefore, in step S19, the contents of works are determined as “others” and command value selector 63 selects a command value e.

Referring back to FIG. 4, then in step S4, the selected command value is outputted. Output unit 65 converts the command value selected by command value selector 63 into a voltage value or the like in accordance with a command format and outputs the resultant value to engine controller 34.

In succession in step S5, computing unit 61 has the estimated contents of works stored in storage 64. The result of present estimation of contents of works can be used in next work categorization.

When the system is not to be started up in determination in step S1 (NO in step S1), ordinary control in which the target rotation speed of engine 31 is set by the operation onto rotation speed setting member 48 is carried out. In step S6, rotation speed setting member 48 outputs to engine controller 34, the operation signal in accordance with the amount of operation thereonto.

Then, in step S7, engine controller 34 sets the target rotation speed of engine 31. Engine controller 34 controls the number of rotations of engine 31 based on the voltage value corresponding to the command value inputted to engine controller 34 in step S4 or the voltage value corresponding to the operation signal inputted to engine controller 34 in step S6.

In succession, whether or not to quit the works is determined (step S8). When the works are not to be quitted (NO in step S8), the process returns to determination in step S1 and the series of processing described above is repeated. When the works are to be quitted, the process ends (“end” in FIG. 4).

### <Functions and Effects>

Characteristic features and functions and effects of the embodiment described above will be summarized as below.

As shown in FIG. 4, when ordinary control is carried out, engine controller 34 controls engine 31 at the target rotation speed based on the operation onto rotation speed setting member 48. When intervention control is carried out, intervention controller 60 estimates the contents of works by work implement 3. Engine controller 34 sets the target rotation speed corresponding to the contents of works estimated by intervention controller 60 and controls engine 31 at the set target rotation speed regardless of the amount of operation onto rotation speed setting member 48.

Intervention controller 60 can finely categorize contents of works by work implement 3. Intervention controller 60 can set the command value selected thereby when it estimates the contents of works by work implement 3 as works not requiring output from engine 31 to be smaller than the command value selected thereby when it estimates the contents of works as works requiring output from engine 31. For example, command value c at the time when the contents of works fall under soil ejection and command value d at the time when the contents of works fall under unloaded revolution can be smaller than command value a at the time when the contents of works fall under excavation and command value b at the time when the contents of works fall under loaded revolution.

Engine controller 34 can set the target rotation speed of engine 31 to be low based on the command value inputted from intervention controller 60. Since the number of rotations of engine 31 can thus be lowered during works not requiring output from engine 31, fuel consumption by engine 31 can be reduced. By automatic adjustment of the number of rotations of engine 31 in accordance with works, fuel efficiency can be improved without deterioration of operability.

As shown in FIG. 4, when ordinary control is carried out, the signal indicating the amount of operation onto rotation speed setting member 48 is inputted from rotation speed setting member 48 to engine controller 34 and engine controller 34 sets the target rotation speed based on the inputted amount of operation. When intervention control is carried out, intervention controller 60 estimates the contents of works by work implement 3, selects the command value corresponding to the estimated contents of works, and outputs the signal indicating the selected command value to engine controller 34. Engine controller 34 sets the target rotation speed based on the inputted command value. Engine 31 is controlled at the thus set target rotation speed, so that the number of rotations of engine 31 can be lowered during works not requiring output from engine 31.

As shown in FIG. 1, hydraulic excavator 100 includes the vehicular body position sensor attached to the vehicular body to detect the position of the vehicular body and the work implement position sensor attached to work implement 3 to detect the position of work implement 3. As shown in FIG. 5, intervention controller 60 estimates the contents of works based on the results of detection by the vehicular body position sensor and the work implement position sensor. Intervention controller 60 computes an attitude of the vehicular body and the work implement based on the results of detection by the vehicular body position sensor and the work implement position sensor, and estimates the contents of works from the attitudes. Intervention controller 60 can thus accurately estimate contents of works done by work implement 3.

As shown in FIG. 3, the results of detection by the vehicular body position sensor and the work implement position sensor are directly inputted to intervention controller 60. Thus, by subsequently providing the vehicular body position sensor and the work implement position sensor in existing hydraulic excavator 100 and interposing intervention controller 60 in the signal path between rotation speed setting member 48 and engine controller 34 to output a signal to engine controller 34, fuel efficiency of hydraulic excavator 100 can be improved. Since other engine control for hydraulic excavator 100 does not have to be modified, control can readily be realized.

As shown in FIG. 5, intervention controller 60 may estimate the contents of works based on the weight of loads loaded on work implement 3. Intervention controller 60 can thus accurately estimate the contents of works by work implement 3.

As shown in FIG. 5, intervention controller 60 may estimate the contents of works based on results of previous estimation of the contents of works. Intervention controller 60 can accurately estimate the contents of works by work implement 3 by estimating the contents of works in consideration of seriality of works.

As shown in FIG. 4, intervention controller 60 may carry out intervention control when the function to measure the weight of loads loaded on work implement 3 has been activated. Thus, which of ordinary control and intervention control is to be carried out can readily and reliably be set based on the operator's intention.

### Second Embodiment

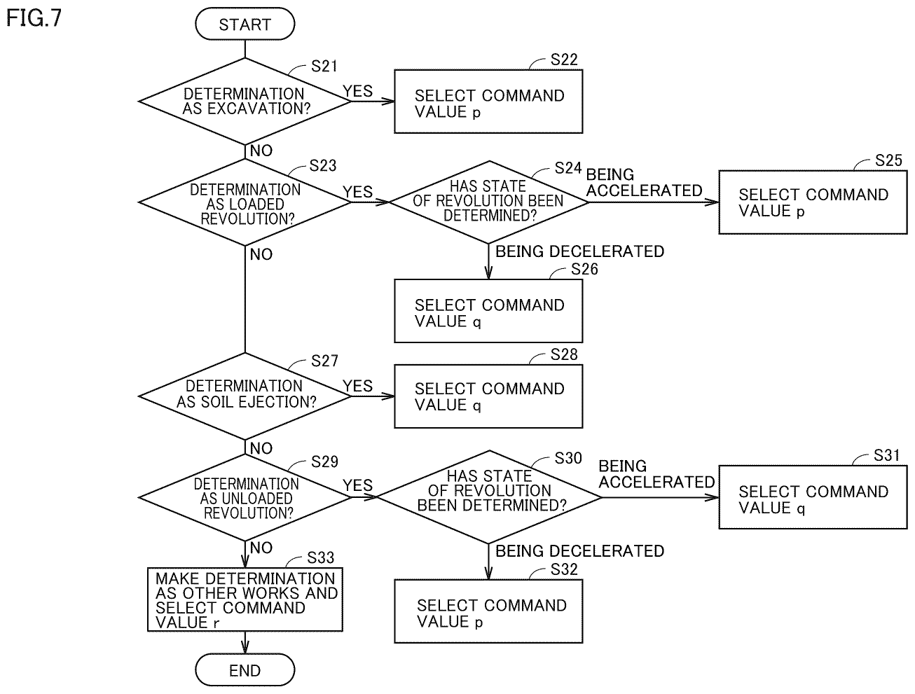

FIG. 7 is a flowchart showing a flow of processing for selecting a command value in a second embodiment. FIG. 7 shows a modification of processing for selection by intervention controller 60, of a setting value corresponding to contents of works.

As shown in FIG. 7, in step S21, whether or not contents of works fall under “excavation” is determined in accordance with the table in FIG. 5. When the contents of works fall under “excavation” (YES in step S21), in step S22, command value selector 63 selects a command value p.

When the contents of works do not fall under “excavation” (NO in step S21), in step S23, whether or not the contents of works fall under “loaded revolution” is determined in accordance with the table in FIG. 5. When the contents of works fall under “loaded revolution” (YES in step S23), then in step S24, a state of revolution is determined. Specifically, an acceleration of revolution of revolving unit 2 with respect to travel unit 1 is determined. The acceleration of revolution of revolving unit 2 can be found from the result of detection by IMU 8a shown in FIG. 1. When revolution is determined as being accelerated, the process proceeds to step S25, and command value selector 63 selects command value p. When revolution is determined as being decelerated, the process proceeds to step S26, and command value selector 63 selects a command value q smaller than command value p.

When the contents of works do not fall under “loaded revolution” (NO in step S23), in step S27, whether or not the contents of works fall under “soil ejection” is determined in accordance with the table in FIG. 5. When the contents of works fall under “soil ejection” (YES in step S27), in step S28, command value selector 63 selects command value q.

When the contents of works do not fall under “soil ejection” (NO in step S27), in step S29, whether or not the contents of works fall under “unloaded revolution” is determined in accordance with the table in FIG. 5. When the contents of works fall under “unloaded revolution” (YES in step S29), then in step S30, the state of revolution is determined. Specifically, the acceleration of revolution of revolving unit 2 with respect to travel unit 1 is determined. When revolution is determined as being accelerated, the process proceeds to step S31 and command value selector 63 selects command value q. When revolution is determined as being decelerated, the process proceeds to step S32 and command value selector 63 selects command value p.

When the contents of works do not fall under “unloaded revolution” (NO in step S29), the works fall under none of “excavation”, “loaded revolution,” “soil ejection,” and “unloaded revolution.” Therefore, the contents of works are determined as “others” in step S33 and command value selector 63 selects a command value r.

According to the processing for selecting the command value in the second embodiment described above, when the contents of works fall under “soil ejection,” command value q smaller than command value p selected at the time when the contents of works fall under “excavation” is selected. During soil ejection works not requiring output from engine 31, engine controller 34 can set the target rotation speed of engine 31 to be low based on command value q. Fuel consumption by engine 31 can thus be reduced and fuel efficiency can be improved.

When revolution of revolving unit 2 is determined as being decelerated in the case where the contents of works fall under “loaded revolution” or “unloaded revolution,” a command value different from the command value selected during acceleration of revolution is selected. Specifically, during acceleration of revolution in “loaded revolution,” command value p which is the same as in “excavation” is selected, and during deceleration of revolution in “loaded revolution,” command value q selected in “soil ejection,” rather than command value p selected in “excavation”, is selected. During acceleration of revolution in “unloaded revolution,” command value q which is the same as in “soil ejection” is selected, and in deceleration of revolution in “unloaded revolution,” command value p selected in “excavation”, rather than command value q selected in “soil ejection,” is selected.

Thus, during deceleration of revolution in “loaded revolution,” in preparation for “soil ejection” works to be done next, output from engine 31 can be lowered. During deceleration of revolution in “unloaded revolution,” in preparation for “excavation” works to be done next, output from engine 31 can be increased. Therefore, a series of loading works in which excavation works, loaded revolution works, soil ejection works, and unloaded revolution works are repeated in this order can smoothly be done.

Though an example in which engine controller 34 and intervention controller 60 are provided separately from each other is described in the embodiments above, limitation thereto is not intended. The same single controller may perform functions of both of engine controller 34 and intervention controller 60 in the embodiments. For example, the function of intervention controller 60 in the embodiments may be added to engine controller 34 of existing hydraulic excavator 100.

Though hydraulic excavator 100 is described by way of example of the work machine in the embodiments, the concept in the present disclosure may be applied to other types of work machines such as a crawler dozer, a wheel loader, and a motor grader, without being limited to hydraulic excavator 100. Though contents of works by work implement 3 are estimated based on the position of the work implement in the embodiments, the contents of works may be estimated by recognition of images of work implement 3.

It should be understood that the embodiments disclosed herein are illustrative and non-restrictive in every respect. The scope of the present invention is defined by the terms of the claims rather than the description above and is intended to include any modifications within the scope and meaning equivalent to the terms of the claims.

### REFERENCE SIGNS LIST

1 travel unit; 2 revolving unit; 3 work implement; 3a boom; 3b arm; 3c bucket; 4a boom cylinder; 4b arm cylinder; 4c bucket cylinder; 6a, 6b pressure sensor; 7a, 7b, 7c stroke sensor; 9a, 9b, 9c angle sensor; 11 payload meter; 13, 14 travel lever; 20, 21 control lever; 31 engine; 32, 32A hydraulic pump; 34 engine controller; 40 hydraulic actuator; 48 rotation speed setting member; 50 engine rotation sensor; 51 oil temperature sensor; 60 intervention controller; 61 computing unit; 62 work categorization unit; 63 command value selector; 64 storage; 65 output unit; 66 switch; 70 sensor; 100 hydraulic excavator

1: A control device of a work machine, the work machine including a vehicular body, a work implement supported on the vehicular body, and an engine which is a drive source of the work implement, the control device comprising:
a rotation speed setting member manually operable for setting a target rotation speed of the engine; and
a controller that selectively carries out any one of ordinary control and intervention control, wherein
in carrying out the ordinary control, the controller controls the engine at the target rotation speed based on an operation onto the rotation speed setting member, and
in carrying out the intervention control, the controller estimates contents of works by the work implement, sets the target rotation speed corresponding to the estimated contents of works, and controls the engine at the set target rotation speed regardless of an amount of operation onto the rotation speed setting member.

2: The control device of a work machine according to claim 1, wherein
the controller includes an engine controller that outputs a control signal to the engine and an intervention controller that is interposed in a signal path between the rotation speed setting member and the engine controller,
when the ordinary control is carried out, a signal indicating the amount of operation onto the rotation speed setting member is inputted from the rotation speed setting member to the engine controller and the engine controller sets the target rotation speed based on the amount of operation that is inputted, and
when the intervention control is carried out, the intervention controller estimates the contents of works by the work implement, selects a command value corresponding to the estimated contents of works, and outputs a signal indicating the command value to the engine controller, and the engine controller sets the target rotation speed based on the command value that is inputted.

3: The control device of a work machine according to claim 1, wherein
the work machine further includes a vehicular body position sensor attached to the vehicular body to detect a position of the vehicular body and a work implement position sensor attached to the work implement to detect a position of the work implement, and
the controller estimates the contents of works based on results of detection by the vehicular body position sensor and the work implement position sensor.

4: The control device of a work machine according to claim 3, wherein
the results of detection by the vehicular body position sensor and the work implement position sensor are directly inputted to the controller.

5: The control device of a work machine according to claim 1, wherein
the controller estimates the contents of works based on a weight of loads loaded on the work implement.

6: The control device of a work machine according to claim 1, wherein
the controller estimates the contents of works based on a result of previous estimation of the contents of works.

7: The control device of a work machine according to claim 1, wherein
the controller carries out the intervention control when a function to measure a weight of loads loaded on the work implement has been activated.
